(19) United States
(12) Patent Application Publication
(10) Pub. No.: US 2026/0195110 A1
(43) Pub. Date: Jul. 9, 2026

(54) MICRO FRONTEND SOFTWARE AND DEPLOYMENT ENVIRONMENT GENERATION

(71) Applicant: Wells Fargo Bank, N.A., San Francisco, CA (US)

(72) Inventors: John Bruno, Scottsdale, AZ (US); Sean Edward Falese, Jenkintown, PA (US); Arnaud Versini, Napa, CA (US)

(21) Appl. No.: 19/008,986

(22) Filed: Jan. 3, 2025

(51) Int. Cl. G06F 8/60; G06F 8/71; G06F 9/54

(52) U.S. Cl. CPC G06F 8/60; G06F 8/71; G06F 9/547

(57) ABSTRACT

Examples are provided for generating and deploying micro frontends within an experience platform. The platform generates a micro frontend conforming to a domain-specific language associated with a predefined system framework. The micro frontend is customizable by developers and is stored in a marketplace for integration into the experience platform. The platform further generates a GraphQL API endpoint with a schema tailored to the requirements of the micro frontend, enabling asynchronous data requests from other components within the platform. A runtime API service and a specialized deployment environment supporting dynamic user interface composition are created, allowing the micro frontend to be deployed across different environments. The platform manages the composition of multiple micro frontends to form individualized user interfaces, applying contextual rules to dynamically adjust the display and functionality of the micro frontends based on user preferences, roles, and operational context.

### BACKGROUND

Modern financial services platforms serve large organizations by providing tools for managing complex financial operations, such as treasury management, payments, cash flow, and international banking. Historically, these platforms have been structured as monolithic applications, leading to lengthy development cycles, isolated product features, and challenges in adapting to evolving user needs. As businesses demand increasingly personalized and seamless user experiences, financial institutions must modernize these platforms while ensuring security, reliability, and compliance with industry regulations.

The conventional strategy of consolidating all features within a single, monolithic application hampers innovation and complicates system upgrades. This approach can result in inefficiencies when delivering new value to users, as development teams must navigate large, complex codebases that require substantial time and resources to modify or improve.

### SUMMARY

Embodiments of the present disclosure relate to a system and method for generating, deploying, and managing micro frontends (MFEs) to modernize financial services platforms. The invention replaces traditional monolithic architectures with a modular approach that leverages MFEs, addressing challenges associated with lengthy development cycles, siloed product features, and limited adaptability to evolving user needs. By tying MFE generation to platform constructs, such as domain-specific languages (DSLs) and tailored API endpoints, the invention facilitates the rapid creation, deployment, and dynamic management of user interfaces. This approach ensures faster development, greater flexibility, and more personalized user experiences while maintaining the security, reliability, and regulatory compliance required in the financial services industry.

In one embodiment, the concept includes a micro frontend generator that creates customizable MFEs conforming to a system's domain-specific language (DSL), which can be deployed and hosted in a specialized production deployment environment. A specialized production deployment environment may include containerized service mesh ecosystems, virtual machines, standalone servers, or cloud containers offering configurations for managing MFE communication and scalability. The system further integrates these MFEs into an experience platform that manages the composition of multiple MFEs to form individualized user interfaces. The platform dynamically adjusts MFEs based on user roles, preferences, and contextual rules, enabling seamless integration and reuse across different applications while reducing inefficiencies caused by traditional monolithic structures.

The invention also supports real-time adaptability through dynamic API endpoints and runtime orchestration, ensuring that MFEs efficiently access and process data as needed. This dynamic management capability enhances both user engagement and development efficiency by enabling rapid updates and ensuring consistent functionality across deployment environments.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example experience platform designed to facilitate the generation and deployment of micro frontends.

FIG. 2 shows example logical components of a server device of the platform of FIG. 1.

FIG. 3 shows an example embodiment of an MFE generator interface of the server device of FIG. 2.

FIG. 4 shows a data source configuration process initiated within the MFE generator interface of FIG. 3.

FIG. 5 depicts an architecture diagram illustrating messaging flows for the adaptive generation and refinement of MFE components, showing interactions between MFE generators, data sources, and development tools.

FIG. 6 depicts an architecture diagram of messaging flows in developing, testing, and deploying MFEs, outlining communication between local development, code repositories, and deployment pipelines.

FIG. 7 depicts an architecture diagram showing the deployment of micrographs as graph conduits in production, with messaging between micrographs, data sources, and front-end applications.

FIG. 8 depicts an architecture diagram of messaging flows for generating and executing a GraphQL API endpoint, illustrating communication between schema generation, resolvers, and frontend components.

FIG. 9 illustrates a method for generating and deploying micro frontends within the experience platform of FIG. 1.

FIG. 10 shows example components of the server device of FIG. 1.

### DETAILED DESCRIPTION

The present disclosure generally relates to generating, managing, and deploying micro frontends within an experience platform to modernize financial services platforms, improve development efficiency, and provide personalized user interfaces.

Large businesses, corporations, and commercial clients use modern financial services platforms to manage operations. These platforms often serve a range of professionals, including treasury teams, CFOs, controllers, and accounts payable and receivable departments. The platforms can provide tools for handling daily cash management, payments, transfers, and loan or credit management. In addition, these platforms often support international banking, trade services, and various automated processes, such as payroll and invoicing, allowing companies to streamline their operations through a centralized, customizable interface. Other features of these platforms can include real-time visibility into account balances, customizable reporting and analytics, and security tools for fraud detection.

Despite their robust capabilities, these financial services platforms can face challenges due to their monolithic design, which effectively isolates products in silos tied to legacy web applications. This siloed structure results in a fragmented and inefficient customer experience, making it difficult for users to navigate the platform and complete tasks smoothly. Moreover, the platforms reliance on monolithic applications often hinders their ability to deliver a more integrated, user-centric experience. As a result, users are compelled to interact with different parts of the platform in isolation, which limits the overall efficiency and effectiveness of their workflows, ultimately diminishing the platform's value.

Additionally, the development dependencies inherent in these monolithic applications contribute to longer cycle times, delaying the delivery of customer value. Modernizing these systems is not only complex but can take several years to complete, further slowing the pace of innovation. This challenge is common among large, established financial institutions, where older technology architectures make it difficult to adapt to the evolving needs of users. As customer expectations grow and the demand for seamless, personalized experiences increases, the platform must be modernized to ensure that it remains competitive.

The proposed solution to the challenges posed by monolithic financial services platforms involves transitioning to a modular architecture based on micro frontends (MFEs). Micro frontends are small, independent parts of the user interface that handle specific functions, such as steps involved in wire transfers, loan approvals, or managing accounts payable. Unlike monolithic applications, where all features are bundled together, these micro frontends can be developed, deployed, and updated separately. This modular approach allows for faster, more efficient development cycles, reducing the complexity associated with managing and upgrading large, integrated systems.

By breaking the platform into smaller, manageable “feature slices,” the solution enables different teams within the organization to develop, maintain, and improve individual components independently. This reduces the dependencies that typically slow down development in monolithic architectures, allowing for more rapid updates and improvements to specific features without the need for large-scale overhauls. Each micro frontend can be customized to meet specific user needs, providing a more tailored and user-centric experience across the platform. Additionally, the modular nature of MFEs ensures that updates to one component do not disrupt the overall functionality of the platform, significantly reducing downtime and enhancing platform stability.

The proposed solution also includes the integration of these micro frontends into a centralized marketplace. The marketplace serves as a repository where newly developed or updated micro frontends can be published, versioned, and made available for immediate integration into the platform. This enables different departments or external partners to access and implement specific micro frontends as needed, fostering collaboration and reducing redundant development efforts. By providing a centralized platform for managing and deploying micro frontends, the marketplace streamlines the integration of new services and ensures consistency across the user interface, improving the overall customer experience.

Furthermore, this modular system supports the dynamic composition of user interfaces, allowing the platform to adapt to the individual needs of each user. Contextual rules and personalization algorithms can be applied to determine which micro frontends are displayed based on user roles, preferences, and historical behavior. This flexibility ensures that users are presented with the most relevant features, enhancing usability and engagement. By leveraging real-time data and machine learning, the platform can continuously refine and improve the user experience, offering a personalized, responsive interface across multiple devices and channels.

Embodiments of the present disclosure are directed to a system and method that are firmly rooted in computer technology and designed to address specific technical challenges associated with modernizing financial services platforms for smoother user experiences and more efficient development of user interfaces when accessing online financial products and services. The subject matter of this invention provides a concrete, technological solution to problems faced by financial institutions using outdated, monolithic architectures. Traditional systems are hindered by inefficiencies, fragmented user experiences, and difficulties in adapting to evolving user needs. The disclosed invention introduces a modular, micro frontend architecture that overcomes these issues by enabling more efficient development, seamless integration, and dynamic user interface customization through the use of MFEs and a marketplace for managing these components.

The invention's use of micro frontends, along with a specialized production deployment environment and a marketplace, constitutes a technical improvement over conventional monolithic designs, enabling financial institutions to scale and adapt in real time. This approach leverages computer systems and networks to deliver more flexible and responsive user experiences while ensuring security and compliance with regulatory standards. As the invention provides a system for generating, deploying, and managing micro frontends within an experience platform, it offers a technical solution that improves the efficiency and scalability of financial services platforms, enhancing both the user experience and development processes for online financial products.

Further elaborations, nuances, and applications of systems utilizing micro front-ends, as described herein, are detailed in the following U.S. Patent Applications: U.S. patent application Ser. No. 17/663,572, filed on May 16, 2022, entitled “Micro Frontend (MFE) Contextual Experiences”; U.S. patent application Ser. No. 18/329,699, filed on Jun. 6, 2023, entitled “Individualized Contextual Experiences”; U.S. patent application Ser. No. 18/329,749, filed on Jun. 6, 2023, entitled “Micro-frontend Composition and Polymorphism”; U.S. patent application Ser. No. 18/333,222, filed on Jun. 12, 2023, entitled “Hub for Micro Front-End Service”; and U.S. patent application Ser. No. 18/519,707, filed on Nov. 27, 2023, entitled “Omni-Channel Micro Frontend Control Plane.” The content, teachings, and disclosures of the aforementioned patent applications are hereby incorporated by reference, to the extent that they do not conflict with the teachings presented herein.

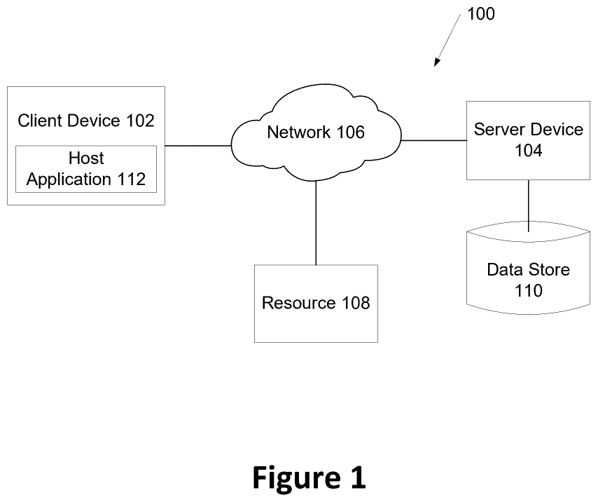

FIG. 1 illustrates a schematic of an experience platform 100 designed to generate and manage micro frontends for integration into an experience platform. The system includes one or more client devices 102, which connect to a server device 104 via a network 106. The client device 102 can access a host application 112, which serves as the interface for developers to create and customize micro frontends. The host application 112 may be made available through a web portal or deployed directly as an application on the client device 102 to enhance development capabilities. Developers can use this interface to generate micro frontends that conform to a domain-specific language (DSL) associated with a predefined system framework, ensuring compatibility with the overall platform architecture.

The server device 104 is connected to a data store 110, which securely stores various types of data required for both the development and operation of micro frontends. This data includes user interaction logs, financial information, transaction records, and any metadata related to the micro frontends themselves. The data store 110 also manages information for ensuring regulatory compliance, including audit logs and security protocols, while maintaining the integrity and confidentiality of sensitive customer data. Additionally, the system can generate a GraphQL API endpoint with a schema tailored to the specific micro frontend, enabling asynchronous data requests between the frontend and other components within the system.

The client device 102, which may include desktop computers, laptops, or other computing hardware, interacts with the server device 104 to execute complex tasks such as generating the micro frontends, managing their customization, and facilitating asynchronous communication through the GraphQL API. The server device 104, which may be a single server or part of a server farm, is equipped with sufficient computational resources, including processors and data storage, to handle these interactions, process data from the data store 110, and ensure that the generated micro frontends function efficiently across different environments.

The network 106 serves as the backbone for communication between the client device 102 and the server device 104, facilitating the exchange of data and commands. This communication allows real-time interaction with the experience platform, ensuring that the micro frontends can request and receive data from other components of the system, as well as interact with other micro frontends as part of a larger, customizable user interface.

In some embodiments, the experience platform 100 can include one or more resources 108, which may include subscription services, machine learning algorithms, or external data services to enhance the development of micro frontends. For example, resource 108 could provide real-time data feeds such as economic indicators, asset prices, or other financial metrics, which are useful for developing dynamic, responsive financial services. Additionally, resource 108 can contribute to the system's runtime API service and specialized production deployment environment, which are configured to deploy and host the micro frontends across different environments, ensuring seamless integration and scalability. The micro frontends are stored in a marketplace, where they can be integrated into the experience platform and composed into individualized user interfaces.

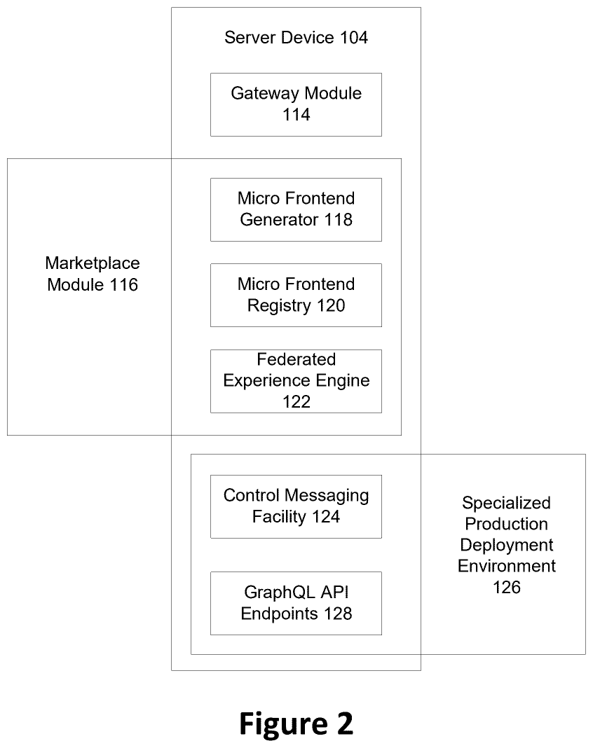

FIG. 2 provides a detailed embodiment of server device 104 within experience platform 100, illustrating its components configured to enable the generation, storage, and management of MFE components. As depicted in FIG. 2, server device 104 may include a gateway module 114, a marketplace module 116, a control messaging facility 124, and a specialized production deployment environment 126. These components operate to support efficient handling and operation of MFEs within the experience platform 100, ensuring seamless data and command exchanges among different system components. Specialized production deployment environment 126, in particular, provides an infrastructure layer that supports secure and reliable communication between MFEs, their associated GraphQL API endpoints 128, and backend services. While a containerized service mesh represents one suitable configuration, the specialized production deployment environment may also include virtual machines, standalone servers, or cloud container environments, ensuring flexibility to operate in diverse infrastructure settings. The ecosystem supports the dynamic management of MFEs by facilitating efficient scaling, updates, and deployment across environments.

In certain embodiments, gateway module 114 is configured to manage user identification, access control, and entitlements, thereby allowing users and third-party platforms to securely authenticate and interact with experience platform 100. Gateway module 114 can ensure that only authorized users access designated financial products, services, or specific MFEs within the system.

Gateway module 114 enables customer identification by verifying users attempting to access the system, employing various authentication methods, such as multi-factor authentication or biometric verification, to maintain a high level of security and safeguard sensitive financial data. By managing security protocols, gateway module 114 helps reduce the risk of unauthorized access and maintains system integrity.

Beyond identification, gateway module 114 manages access permissions across the system by determining which users are authorized to interact with specific MFEs. By maintaining detailed records of user roles and entitlements, gateway module 114 provides a secure, customized user experience, allowing users to access only the resources they are permitted to use, thereby ensuring compliance with access policies and protecting system data integrity.

Marketplace module 116 is configured to provide users with a library of MFEs, APIs, and other resources accessible through host application 112. This marketplace enables users to browse and select MFE components aligned with specific needs, facilitating integration of various financial products and services into third-party platforms. As shown in FIG. 2, marketplace module 116 may include subcomponents such as MFE generator 118, MFE registry 120, and federated experience engine 122.

MFE generator 118 is designed to create new MFEs as modular, independent components that integrate into larger applications. This modularity allows each MFE to serve a specific function within the user interface, functioning as a self-contained unit that can be developed, tested, and deployed independently. By allowing MFEs to operate as discrete modules, the system enables seamless updates and customizations without disrupting other parts of the application, ensuring adaptability and flexibility.

Through host application 112, client device 102 can interact with MFE generator 118 to create MFEs tailored to specific customer needs. Host application 112 provides developers with tools such as pre-built templates, configuration wizards, and drag-and-drop interfaces, streamlining the MFE creation process and reducing the need for manual coding. This setup allows developers to quickly create MFEs tailored to unique user requirements, accelerating the integration of personalized user interfaces and improving development efficiency.

An important feature of MFE generator 118 is its ability to generate a tailored GraphQL API endpoint for each MFE, thereby optimizing data requests to meet the specific needs of the frontend. The generated API endpoint serves as an access point for the MFE to fetch or send data customized to retrieve only information relevant to that MFE's functionality. For example, if an MFE is designed to display user profiles, the GraphQL API endpoint is configured to fetch only the necessary profile data, thereby avoiding unnecessary data retrieval. This approach leverages the flexibility of GraphQL to define query-based data requests that align precisely with the frontend's requirements, which reduces over-fetching or under-fetching of data common with traditional REST APIs. GraphQL's hierarchical data requests also allow for efficient, structured responses, enhancing the frontend's ability to display complex UI structures effectively.

Once created, MFEs integrate seamlessly into software platforms to enhance the user experience on client devices 102. For example, a financial institution may use MFE generator 118 to create an MFE displaying real-time financial data, such as account balances or recent transactions, tailored to fetch only the necessary data from backend services via the customized GraphQL API endpoint. This MFE can then be embedded within third-party platforms, offering users a cohesive, personalized experience. Additionally, the independent nature of MFEs ensures that each component can be updated or modified independently of the larger platform, providing ongoing flexibility and scalability as user needs and platform requirements evolve.

MFE registry 120 serves as a centralized catalog for storing and managing MFEs, accessible by authorized developers. Each MFE in MFE registry 120 is developed in compliance with a DSL to ensure standardized communication across the system, enabling efficient retrieval and reuse by developers.

MFE registry 120 validates all MFEs against required conformance criteria, such as technical, design, and performance specifications, thereby preserving system compatibility and reliability. This validation ensures that all MFEs meet system quality and performance standards.

In addition to supporting MFE creation and validation, MFE registry 120 catalogs MFEs based on parameters such as function, usage context, and distinguishing attributes, facilitating efficient retrieval and application. The registry also enables the combination of multiple MFEs to create more complex user interface components, thereby enhancing the versatility of the micro frontend ecosystem and supporting rapid interface development and deployment.

Federated experience engine 122 retrieves MFEs from MFE registry 120 and orchestrates user experiences across multiple communication channels, thereby ensuring consistent, optimized interactions tailored to each channel's characteristics, enabling a cohesive experience across web, mobile, and other interfaces.

In certain embodiments, federated experience engine 122 defines APIs to facilitate the registration of new MFEs within MFE registry 120, ensuring compliance with system standards.

Federated experience engine 122 also supports personalized user experiences by considering factors like user roles, preferences, and behavior-based recommendations for MFEs. Federated experience engine 122 enables MFEs to integrate seamlessly with the interconnected mesh ecosystem, allowing for state transitions, analytical data collection, activity tracking, and features such as deep linking and feedback mechanisms. Unlike service mesh proper (e.g., Istio), the interconnected mesh ecosystem is tailored to support dynamic composition and management of MFEs within the experience platform.

Control messaging facility 124 coordinates communication between components of experience platform 100, particularly across different communication channels, standardizing protocols and formats to ensure consistent interactions between MFEs and other system elements and preserving data integrity.

Control messaging facility 124 includes mechanisms for queuing, prioritizing, and routing messages based on predefined rules, directing messages to specific components, such as MFEs or federated experience engine 122, based on context, ensuring accurate message delivery and coordination.

By facilitating cross-channel communication, control messaging facility 124 ensures that interactions on one channel influence user experiences on another. For example, if a state transition occurs on one interface, control messaging facility 124 can relay this to another channel, maintaining a consistent and interconnected experience across platforms, allowing experience platform 100 to deliver a cohesive, responsive user experience.

Specialized production deployment environment 126 serves as a dedicated infrastructure layer that manages and controls communication among various MFEs, their associated GraphQL API endpoints 128, and other components, including control messaging facility 124. Specialized production deployment environment 126 can include a containerized service mesh, a virtual machine, a standalone server, or a cloud container environment, each providing a secure and efficient communication framework. In one embodiment, the environment encapsulates each MFE and API endpoint within a containerized configuration, facilitating modularity, secure interactions, and efficient communication across system components.

Specialized production deployment environment 126 encapsulates each MFE and its associated GraphQL API endpoint 128 within a specialized production deployment environment. Each container represents a lightweight, portable unit that packages an MFE or service with all dependencies, ensuring consistent behavior across environments. For instance, if an MFE retrieves user profile data, the corresponding container includes the MFE code, the GraphQL API endpoint configured to fetch only relevant user profile fields, and any dependencies required for operation. This encapsulation promotes modularity and enables independent deployment, updates, and scaling.

The specialized production deployment environment 126 organizes these containers and governs their communication through a secure, managed network layer within the server infrastructure. This layer establishes controlled connections, enabling MFEs to request only the data they need. For instance, when an MFE requests user-specific data, the service mesh directs the request through the appropriate API endpoint, optimizing data transfer and supporting an efficient user experience.

The specialized production deployment environment 126 employs security protocols to protect data exchanges within server device 104, using secure, encrypted channels to safeguard sensitive financial data and user information. It enforces authentication and authorization rules, ensuring that MFEs and API endpoints interact only with authorized components based on predefined access levels.

The specialized production deployment environment 126 further enhances the scalability and resilience of server device 104. As user demand fluctuates, the service mesh dynamically adjusts active containers, scaling MFEs and API endpoints as needed to handle increased traffic without compromising performance. The service mesh also facilitates load balancing, distributing requests evenly and preventing bottlenecks.

Additionally, the specialized production deployment environment 126 manages communication with control messaging facility 124, which coordinates messages between components, leveraging the service mesh to prioritize and route messages efficiently. This integration provides a consistent, unified user experience, allowing experience platform 100 to deliver responsive and cohesive interactions across diverse interfaces.

Server device 104 includes an API service, automatically configured to address the specific communication, data management, and runtime needs of MFEs. This API service is tailored to provide each MFE with a customized pathway to interact with backend services, managing data requests efficiently.

The API service manages data exchanges between MFEs and backend services, allowing real-time data fetching, updating, or processing. At runtime, the API service ensures that each MFE requests only the data it needs to perform its function, minimizing the risk of over-fetching or under-fetching.

Additionally, the API service supports efficient data handling through a flexible, query-based structure, adapting to each MFE's requirements. Using a GraphQL-based approach, the API service allows MFEs to specify needed fields, enhancing responsiveness by providing hierarchical data on demand.

Designed to operate at runtime, the API service processes data interactions and adapts responses based on user inputs and actions, ensuring MFEs access up-to-date information. For example, when a user initiates a transaction, the API service communicates with backend services to complete the transaction, providing immediate feedback.

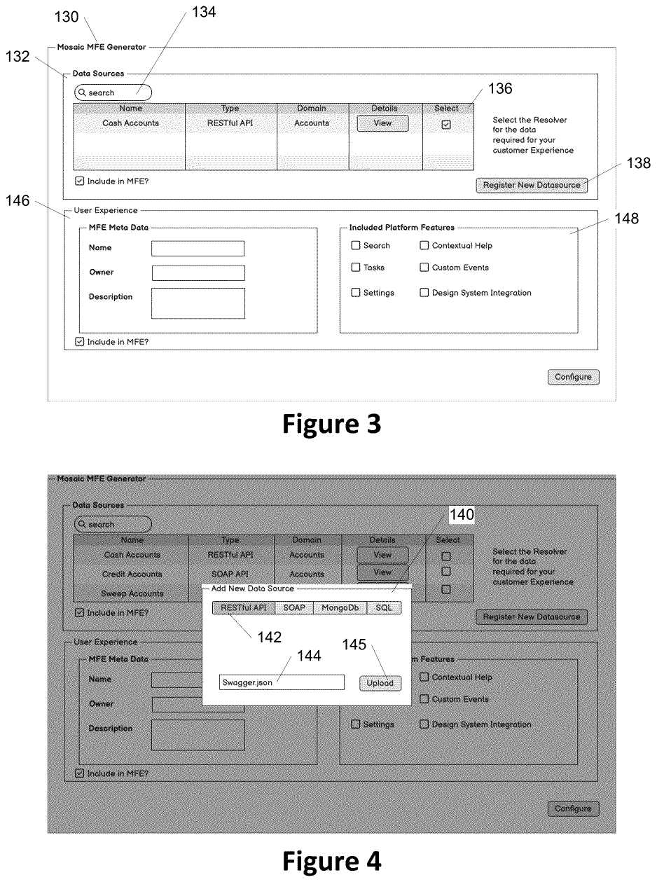

FIG. 3 depicts an example embodiment of an MFE generator interface 130, configured to allow a user to manage and configure data sources for MFE components within experience platform 100. The MFE generator interface 130 provides tools and fields for selecting, registering, and organizing data sources available for generated MFEs, centralizing these functions to streamline data integration.

The MFE generator interface 130 includes a data sources section 132, which displays available data sources for selection and integration into MFEs. Data sources section 132 allows users to view attributes such as type and domain, supporting selection based on specific requirements.

Within the data sources section 132 is a search bar 134, which enables filtering of data sources based on keywords or parameters, allowing users to efficiently locate data sources by relevant terms, such as name, type, or domain.

The data sources section 132 further includes a data sources table 136, which lists available data sources in structured columns—such as name, type, domain, details, and select—corresponding to individual data sources. The select column allows a user to specify a particular data source for MFE integration, with data sources table 136 providing at-a-glance access to necessary details. The MFE generator interface 130 includes a register new data source button 138, which, when selected, initiates the registration of a new data source.

As shown in FIG. 4, activating data source button 138 opens a new data source pop-up window 140, guiding the user through data source setup. The new data source pop-up window 140 provides fields for defining attributes of the new data source. Within this window, data source type checkboxes 142 allow the user to specify the data source type, such as RESTful API, SOAP, MongoDB, or SQL, for backend compatibility.

The new data source pop-up window 140 also includes a file name text field 144 for inputting a name associated with the data source, aiding in its future identification. The entered file name appears in data sources table 136 upon registration.

The upload button 145 in the new data source pop-up window 140 finalizes the registration, uploading the data source configuration to integrate it within data sources section 132. After uploading, the new data source is available in data sources table 136 for selection and MFE integration, expanding the data options accessible to MFEs within experience platform 100.

Referring further to FIG. 3, the MFE generator interface 130 can include a user experience section 146 for configuring metadata associated with generated micro frontend components. The user experience section 146 may include an MFE metadata block with fields for name, owner, and description, allowing input of identifiers and descriptive information that support MFE organization and traceability within experience platform 100. The metadata block can further include an “include MFE” checkbox to indicate whether the MFE should be deployed as an active component.

Adjacent to the user experience section 146, the MFE generator interface 130 can include an included platform features section 148 with checkboxes for enabling specific functionalities, such as search, tasks, settings, contextual help, custom events, and design system integration. Each checkbox allows selective activation of features to extend the MFE's capabilities within the broader platform.

For example, selecting the search option can enable querying capabilities, while the tasks option can facilitate task management. Settings can allow user-configurable options, contextual help provides on-demand guidance, custom events enable defined interactions, and design system integration aligns the MFE visually and functionally with platform standards. Collectively, these configurable options enable tailored functionality within experience platform 100, enhancing the MFE's adaptability across various applications.

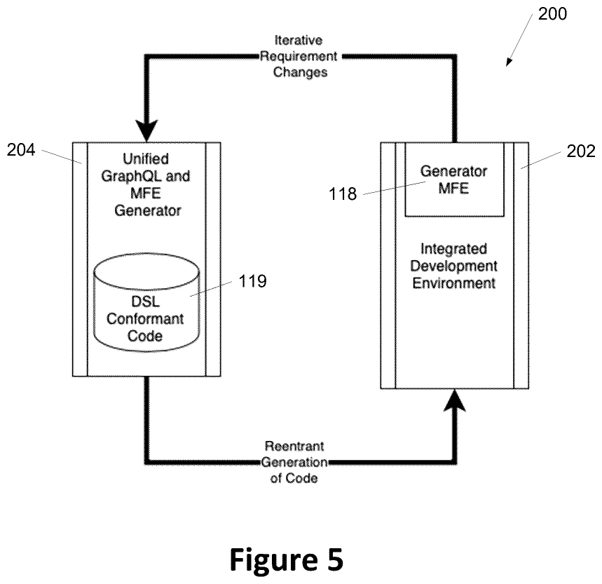

Referring to FIG. 5, an architecture diagram illustrating a method 200 for messaging flows is depicted, showing the adaptive generation and refinement of MFE components through interactions between MFE generators, data sources, and development tools. Method 200 includes the MFE generator 118, operating within an integrated development environment (IDE), to enable a flexible and reentrant framework for MFE creation, storage, and adaptation within the server device 104, as previously described in FIG. 2.

In step 202 of method 200, the IDE is provided via an MFE generator 118, which is configured to allow developers to build and modify MFE components dynamically. Through the IDE, developers interact with the MFE generator 118 to iteratively create MFEs that meet current system requirements and can be tailored to specific business needs. This IDE environment facilitates both initial MFE generation and subsequent refinement, contributing to the adaptability of server device 104 in response to evolving user requirements.

In step 204, a unified GraphQL and MFE generator is provided, configured to store and manage DSL-conformant code in database 119 in a structured database. This unified generator enables consistent, streamlined MFE generation that aligns with the system's domain-specific language standards, ensuring uniformity across MFEs and supporting effective integration within an infrastructure of the server device 104. By accessing the database 119 for DSL-conformant code, the unified GraphQL and MFE generator also supports reentrant generation capabilities, allowing MFE components to be continuously updated and refined without compromising system consistency.

A flow labeled iterative requirement changes originates from the IDE in step 202 and directs feedback to the unified GraphQL and MFE generator in step 204, facilitating iterative adjustments to MFE components based on updated business requirements. This flow enables the unified GraphQL and MFE generator to incorporate changes into the DSL-conformant codebase stored in database 119 as requirements evolve.

Another flow, labeled “reentrant generation of code,” flows from the unified GraphQL and MFE generator in step 204 back to the IDE in step 202. This reentrant flow allows the system to retrieve and refine stored DSL-conformant code, enabling the MFE generator 118 to update MFEs within the IDE based on current standards and requirements.

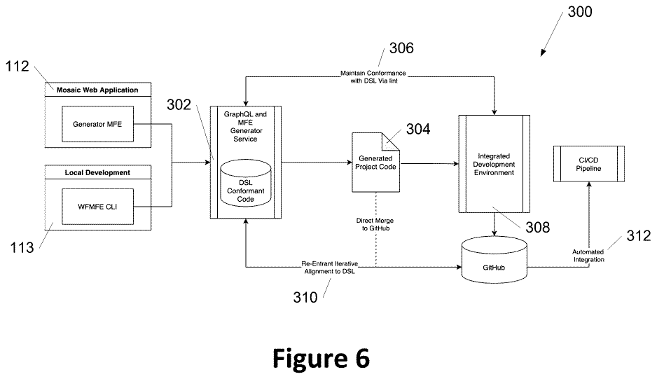

FIG. 6 depicts an architecture diagram illustrating a method 300 for messaging flows in developing, testing, and deploying MFEs, outlining communication between local development environments, code repositories, and deployment pipelines. Method 300 ensures that the generated components adhere to system requirements and remain compatible with the overall application framework.

The diagram in FIG. 6 initiates with the host application 112 and a local development block comprising an MFE Command-Line Interface (CLI) 113. The host application 112 provides developers with access to the MFE generator 118, facilitating the configuration and generation of MFEs according to predefined requirements. The MFE CLI 113 enables developers within a local development environment to initiate and customize MFEs directly, thereby affording flexibility in configuring MFEs to meet specific needs prior to their integration into the experience platform 100.

At step 302, the host application 112 and the local development environment interface with the GraphQL and MFE generator service, which is configured to generate MFEs and establish their corresponding GraphQL API endpoints. This service, referenced in step 204 of the method 200, is responsible for producing project code that is tailored to the specific requirements of each MFE. The GraphQL and MFE generator service not only generates the project code but also ensures compliance with the DSL defined for experience platform 100.

At step 304, the generated project code is transmitted to an integrated development environment (IDE) 121, wherein developers can review, test, and refine the MFE code. The IDE 121 provides developers with tools to implement any necessary modifications, ensuring that the MFE conforms to system standards and meets designated functional requirements.

At step 306, automated code linting is performed to verify adherence to DSL rules. This linting process enforces consistency with the DSL, thereby identifying and resolving discrepancies at an early stage in the development process.

Upon completion of refinement within the IDE 121, at step 308, the project code may be committed to an MFE registry 120 (e.g., GitHub). The MFE registry 120 serves as a repository for all generated MFE code, facilitating version control and collaborative development among developers.

At step 310, an iterative update process may be employed, allowing any modifications to the MFE code to maintain alignment with the DSL. This reentrant pipeline provides a continuous feedback loop, enabling seamless updates to the MFE code without compromising its conformity with system standards.

At step 312, the MFE registry 120 interfaces with a CI/CD pipeline (Continuous Integration/Continuous Deployment), which automates the deployment of MFEs into production environments. The CI/CD pipeline ensures that each MFE component undergoes rigorous testing and validation prior to deployment, thereby maintaining the integrity and functionality of the deployed MFEs.

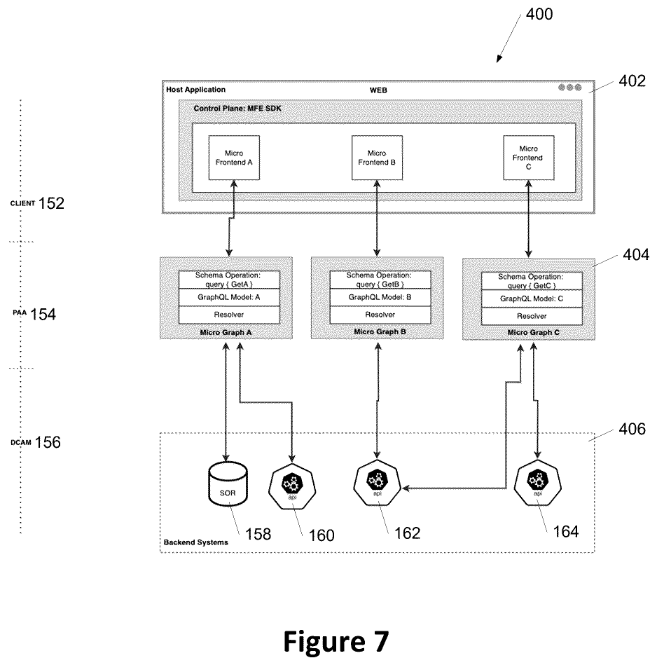

FIG. 7 depicts an architecture diagram illustrating a method 400 for the deployment of micrographs as graph conduits in production, showing messaging flows between micrographs, data sources, and front-end applications. Method 400 ensures that each micro frontend is aligned with a corresponding micrograph to support efficient and organized data queries, modeling, and resolution processes. FIG. 7 is divided into three sections representing different operational layers: a client operational layer 152, a Platform API Aggregator (PAA) operational layer 154, and a Data Collection and Access Management (DCAM) operational layer 156.

Beginning at the client operational layer 152, at step 402, the host application 112 is deployed, providing an interface for user interactions. The host application 112 includes a control plane: MFE SDK (Micro Frontend Software Development Kit), which contains multiple micro frontends respectively labeled Micro Frontend A, Micro Frontend B, and Micro Frontend C, each representing a self-contained component within the SDK, each handling specific functions or views within the user interface.

At step 404, each micro frontend is aligned with a corresponding micrograph in the PAA operational layer 154, which acts as a graph conduit to streamline data requests and processing. Specifically Micro Frontend A is connected to Micro Graph A, Micro Frontend B is connected to Micro Graph B, and Micro Frontend C is connected to Micro Graph C, with each micrograph configured to serve the unique data needs of its associated MFE. For instance, Micro Graph A contains subcomponents labeled schema operation: query (GetA), GraphQL Model, and resolver. These subcomponents support querying, data modeling, and data resolution, enabling Micro Frontend A to retrieve and process only the required data for its function. Micro Graph B and Micro Graph C are similarly configured, each with a query, model, and resolver tailored to their associated micro frontend.

At step 406, the DCAM operational layer 156 serves as the backend data access layer, providing the necessary system of record (SOR) and APIs required to fulfill the queries generated by the micrographs. For example, an SOR 158 and an API 160 within the DCAM layer are connected to Micro Graph A to supply data for the queries defined by GetA. Similarly, a second API 162 is linked to both Micro Graph B and Micro Graph C, supporting the data needs of these micrographs. Additionally, a third API 164 within the DCAM operational layer 156 is exclusively connected to Micro Graph C, providing specific backend resources that are unique to this micrograph's operations.

Thereafter each micrograph retrieves data from the appropriate SOR or API within the DCAM layer based on the schema and queries defined in the PAA layer. This configuration enables each micro frontend to access its designated data efficiently, as the schema, model, and resolver within each micrograph ensure that only the necessary data is retrieved from the backend. For instance, Micro Graph A is configured to execute query (GetA) to retrieve only relevant data for Micro Frontend A, while the schema and resolver optimize how this data is structured and returned.

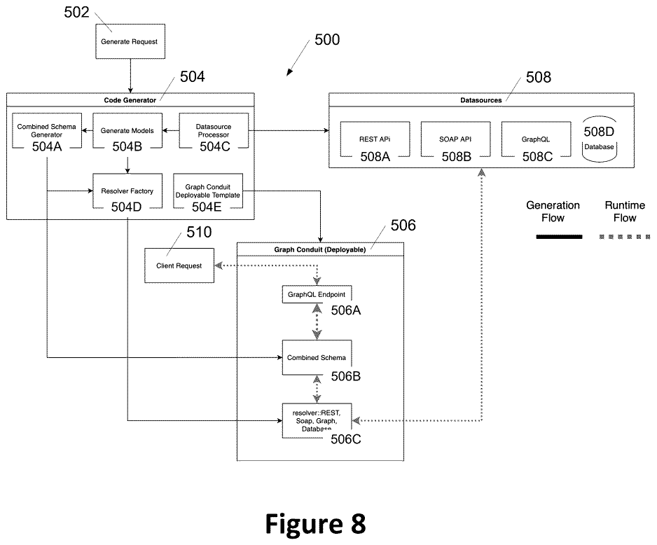

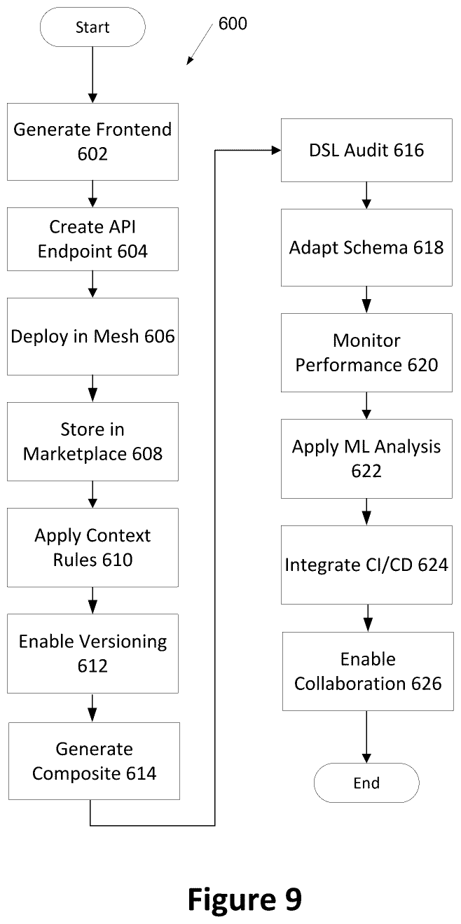

FIG. 8 depicts an architecture diagram illustrating a method 500 for messaging flows involved in generating and executing a GraphQL API endpoint, showing communication between schema generation, resolvers, and frontend components. Method 500 defines a structured approach for both the generation and runtime flows of the GraphQL API endpoint, ensuring optimized data access and retrieval tailored to the requirements of the micro frontend within a production environment.

At step 502, the method initiates with a generate request, which triggers the API endpoint generation process. This request details the unique data requirements and configurations of the micro frontend, establishing parameters that guide the generation of the GraphQL API endpoint and its associated schema.

The request is subsequently directed to a code generator, such as the MFE generator 118, which, at step 504, executes a series of processes to construct the tailored GraphQL API. The code generator first produces a comprehensive schema that aggregates the necessary data fields from various backend sources, ensuring alignment with the data requirements of the micro frontend. It then generates data models that structure and organize the data to support the intended functionality of the micro frontend, ensuring that the retrieved data conforms to the defined schema. Additionally, the code generator identifies and establishes connections to appropriate backend data sources that will supply the required information. The code generator further creates resolvers, each configured to handle data retrieval and manipulation in accordance with the schema, enabling the resolvers to fetch data from specific backend sources. Finally, the code generator configures the deployable GraphQL API, assembling all necessary components into a deployable format that aligns with the data needs of the micro frontend.

At step 506, the code generator interfaces with a deployable graph conduit, facilitating the tailored deployment of the GraphQL API. As part of this deployment, a GraphQL endpoint is set up to serve as the primary access point for data requests from the micro frontend. Additionally, a schema is generated to structure the data retrieved from backend sources, defining the fields and data relationships that meet the requirements of the micro frontend. The resolver is also configured to handle data retrieval from each designated data source, enabling the GraphQL API to fetch data as needed from REST, SOAP, GraphQL, or Database sources. This resolver configuration allows the API to dynamically adapt to the backend source in use, thereby optimizing data retrieval based on the specific data sources required.

At step 508, connections to the data sources are established, including connections to a REST API, SOAP API, GraphQL API, and a database. The data source connection process provided by step 504 evaluates the parameters of the generate request to determine which of these sources will supply the required data, allowing data to be sourced flexibly from multiple backend systems to fulfill the data requirements of the micro frontend.

The runtime flow, represented by a dashed line, connects step 506 to the data sources at step 505. At runtime, the resolver actively engages with the identified data sources based on the combined schema, dynamically retrieving the specific data fields requested by the micro frontend. Additionally, at step 510, data requests originating from the client side may be received, enabling the micro frontend's runtime flow to leverage a separate GraphQL source if needed. This connection allows the micro frontend to query data in a flexible and efficient manner, retrieving only the information pertinent to the client request and enhancing the overall responsiveness of the system.

FIG. 9 illustrates a method 600 for generating and deploying micro frontends within an experience platform, as recited in claims 11-20. Method 600 enables the creation, deployment, and management of micro frontends in a manner that facilitates their integration into a dynamic experience platform, allowing for real-time customization, scalability, and responsive data interactions across different user environments.

At step 602, method 600 begins by generating a micro frontend conforming to a DSL associated with a predefined system framework. The DSL is used to ensure that the micro frontend is structured in alignment with the overall system framework, allowing seamless integration and functionality within the experience platform. This generation process includes customization options, enabling developers to tailor the micro frontend's interface and functionality according to specific design and operational requirements.

At step 604, a GraphQL API endpoint is generated with a schema that is tailored to the specific requirements of the micro frontend. The API endpoint supports asynchronous requests and enables the micro frontend to fetch and process data from other system components as needed. The schema is specifically designed to align with the micro frontend's data needs, optimizing data retrieval and minimizing unnecessary data transfers. This tailored configuration allows the micro frontend to request only the data it requires to operate effectively within the experience platform.

At step 606, a runtime API service and a specialized production deployment environment are created to deploy and host the micro frontend across different environments. The runtime API service serves as an operational layer that manages the interactions between the micro frontend and other system components in real time. The specialized production deployment environment provides a secure and scalable infrastructure that enables seamless communication between micro frontends, their associated GraphQL API endpoints, and backend services. This containerized setup ensures that the micro frontend can be deployed flexibly across various environments, while maintaining compatibility with the system's requirements.

At step 608, the micro frontend is stored in a marketplace for integration into the experience platform. The marketplace serves as a centralized repository where developers can access and manage micro frontends, including version control, template selection, and deployment options. The experience platform leverages the marketplace to manage the composition of multiple micro frontends, enabling the creation of individualized user interfaces. Through this configuration, the experience platform can dynamically assemble micro frontends based on user interactions, contextual data, and operational requirements, providing a tailored user experience.

At step 610, contextual rules are applied during runtime to determine which of a plurality of micro frontend templates are displayed in the marketplace. These rules consider factors such as user preferences, historical behavior, and operational context, allowing the experience platform to offer a personalized interface selection for each user. This contextual rule application enables adaptive and responsive interface configurations that align with user expectations and preferences.

At step 612, version control functionality is enabled within the marketplace, allowing developers to select, update, or revert to previous versions of the micro frontend. This functionality supports the maintenance and evolution of each micro frontend within the experience platform, giving developers the flexibility to manage different versions as new features or adjustments are introduced.

At step 614, a composite micro frontend is generated, comprising two or more sub-micro frontends. The composite frontend asynchronously requests and collects responses from the sub-micro frontends, rendering them as a unified user interface element. This composite structure allows for a more comprehensive and cohesive user experience, as multiple functionalities are combined into a single interface, streamlining the user's interaction with the platform.

At step 616, an audit of the DSL used during the generation of the micro frontend is performed to ensure compatibility with other micro frontends within the experience platform. This auditing process verifies that each micro frontend aligns with system standards, facilitating smooth integration and interoperability within the platform.

At step 618, the schema of the GraphQL API endpoint is adapted by analyzing the operational parameters of the micro frontend. This adaptation optimizes data requests by modifying the schema in response to real-time usage patterns, improving data access efficiency based on the specific needs and behavior of the micro frontend.

At step 620, the performance and security of the micro frontend are monitored within the specialized production deployment environment to ensure that the micro frontend meets predefined performance, security, and compatibility standards. This monitoring function provides continuous oversight, helping to identify and address potential issues related to security, responsiveness, or resource usage.

At step 622, machine learning algorithms are applied to analyze user interactions with the micro frontend, providing personalized recommendations for which of a plurality of micro frontend templates or configurations should be deployed. This analysis enables the experience platform to tailor the user interface dynamically, adjusting in response to user activity and preferences to enhance the user experience.

At step 624, the marketplace is integrated with a code repository and a continuous integration/continuous deployment (CI/CD) pipeline. This integration facilitates automated testing, validation, and deployment of micro frontends, streamlining the development lifecycle and allowing for rapid deployment of updates to the experience platform.

At step 626, collaboration between multiple developers is facilitated by enabling concurrent development of a plurality of micro frontends. Each micro frontend is independently versioned and maintained within the marketplace, supporting collaborative development practices and allowing multiple developers to work on different micro frontends simultaneously without interference.

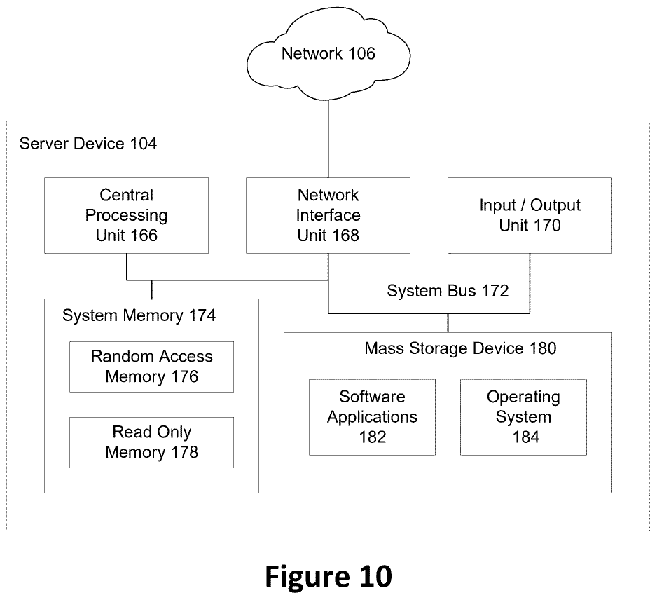

As illustrated in the embodiment of FIG. 10, the example server device 104, which provides the functionality described herein, can include at least one central processing unit (CPU) 166, a system memory 174, and a system bus 172 that couples the system memory 174 to the CPU 166. The system memory 174 includes a random access memory (RAM) 176 and a read-only memory (ROM) 178. A basic input/output system containing the basic routines that help transfer information between elements within the server device 104, such as during startup, is stored in the ROM 178. The server device 104 further includes a mass storage device 180. The mass storage device 180 can store software instructions and data. A central processing unit, system memory, and mass storage device similar to that shown can also be included in the other computing devices disclosed herein.

The mass storage device 180 is connected to the CPU 166 through a mass storage controller (not shown) connected to the system bus 172. The mass storage device 180 and its associated computer-readable data storage media provide non-volatile, non-transitory storage for the server device 104. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (DVDs), other optical storage media, magnetic cassettes, magnetic tape, magnetic disk storage or other magnetic storage devices, or any other medium which can be used to store the desired information and which can be accessed by the server device 104.

According to various embodiments of the invention, the server device 104 may operate in a networked environment using logical connections to remote network devices through network 106, such as a wireless network, the Internet, or another type of network. The network 106 provides a wired and/or wireless connection. In some examples, the network 106 can be a local area network, a wide area network, the Internet, or a mixture thereof. Many different communication protocols can be used.

The server device 104 may connect to network 106 through a network interface unit 168 connected to the system bus 172. It should be appreciated that the network interface unit 168 may also be utilized to connect to other types of networks and remote computing systems. The server device 104 also includes an input/output controller 170 for receiving and processing input from a number of other devices, including a touch user interface display screen or another type of input device. Similarly, the input/output controller 170 may provide output to a touch user interface display screen or other output devices.

As mentioned briefly above, the mass storage device 180 and the RAM 176 of the server device 104 can store software instructions and data. The software instructions include an operating system 184 suitable for controlling the operation of the server device 104. The mass storage device 180 and/or the RAM 176 also store software instructions and applications 182, that when executed by the CPU 166, cause the server device 104 to provide the functionality of the server device 104 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A system, comprising:
at least one processor; and
non-transitory computer-readable storage storing instructions that, when executed by the at least one processor, cause the system to:
generate a micro frontend conforming to a domain-specific language associated with a predefined system framework, wherein the micro frontend is customizable by a developer;
generate a GraphQL API endpoint with a schema tailored to requirements of the micro frontend, enabling the micro frontend to asynchronously request and receive data from other components within the system;
create a runtime API service and a specialized production deployment environment configured to deploy and host the micro frontend across different environments; and
store the micro frontend in a marketplace for integration into an experience platform, wherein the experience platform manages a composition of multiple micro frontends to form individualized user interfaces.

2. The system of claim 1, wherein the specialized production deployment environment comprises one or more of a containerized service mesh, a virtual machine, a standalone server, or a cloud container environment.

3. The system of claim 1, wherein the instructions further cause the system to apply contextual rules during runtime to determine which of a plurality of micro frontend templates are displayed in the marketplace based on user preferences, historical behavior, and operational context.

4. The system of claim 1, wherein the marketplace includes version control functionality, allowing developers to select, update, or revert to previous versions of the micro frontend for deployment within the experience platform.

5. The system of claim 1, wherein the instructions further cause the system to generate a composite micro frontend comprising two or more sub-micro frontends, and wherein the system asynchronously requests and collects responses from the two or more sub-micro frontends to render the composite micro frontend as a unified user interface element.

6. The system of claim 1, wherein the instructions further cause the system to audit the domain-specific language used during generation of the micro frontend to ensure compatibility with other micro frontends within the experience platform.

7. The system of claim 1, wherein the instructions further cause the system to adapt the schema of the GraphQL API endpoint by analyzing operational parameters of the micro frontend.

8. The system of claim 1, wherein the specialized production deployment environment includes monitoring and governance tools to ensure that the micro frontend meets predefined performance, security, and compatibility standards.

9. The system of claim 1, wherein the instructions further cause the system to apply machine learning algorithms to analyze user interactions with micro frontends, providing personalized recommendations for which of a plurality of micro frontend templates or configurations should be deployed based on user activity and preferences.

10. The system of claim 1, wherein the marketplace is integrated with a code repository and continuous integration/continuous deployment pipeline, enabling automated testing, validation, and deployment of micro frontends to the experience platform.

11. The system of claim 1, wherein the instructions further cause the system to facilitate collaboration between multiple developers by enabling concurrent development of a plurality of micro frontends, wherein each of the plurality of micro frontends is independently versioned and maintained in the marketplace.

12. A method for generating and deploying micro frontends within an experience platform, comprising:
generating, by at least one processor, a micro frontend conforming to a domain-specific language associated with a predefined system framework, wherein the micro frontend is customizable by a developer;
generating a GraphQL API endpoint with a schema tailored to requirements of the micro frontend, enabling the micro frontend to asynchronously request and receive data from other components;
creating a runtime API service and a specialized production deployment environment configured to deploy and host the micro frontend across different environments; and
storing the micro frontend in a marketplace for integration into the experience platform, wherein the experience platform dynamically manages a composition of multiple micro frontends to form individualized user interfaces.

13. The method of claim 12, wherein the specialized production deployment environment comprises one or more of a containerized service mesh, a virtual machine, a standalone server, or a cloud container environment.

14. The method of claim 12, further comprising applying contextual rules during runtime to determine which of a plurality of micro frontend templates are displayed in the marketplace based on user preferences, historical behavior, and operational context.

15. The method of claim 12, further comprising enabling version control functionality within the marketplace, allowing developers to select, update, or revert to previous versions of the micro frontend for deployment within the experience platform.

16. The method of claim 12, further comprising generating a composite micro frontend comprising two or more sub-micro frontends, and asynchronously requesting and collecting responses from the two or more sub-micro frontends to render the composite micro frontend as a unified user interface element.

17. The method of claim 12, further comprising auditing the domain-specific language used during generation of the micro frontend to ensure compatibility with other micro frontends within the experience platform.

18. The method of claim 12, further comprising adapting the schema of the GraphQL API endpoint by analyzing operational parameters of the micro frontend to optimize data requests.

19. The method of claim 12, further comprising monitoring performance and security of the micro frontend in the specialized production deployment environment to ensure that the micro frontend meets predefined performance, security, and compatibility standards.

20. The method of claim 12, further comprising applying machine learning algorithms to analyze user interactions with the micro frontend and provide personalized recommendations for which of a plurality of micro frontend templates or configurations should be deployed based on user activity and preferences.

21. The method of claim 12, further comprising integrating the marketplace with a code repository and continuous integration/continuous deployment pipeline, enabling automated testing, validation, and deployment of micro frontends to the experience platform.

22. The method of claim 12, further comprising facilitating collaboration between multiple developers by enabling concurrent development of a plurality of micro frontends, wherein each of the plurality of micro frontends is independently versioned and maintained in the marketplace.
